(19) United States
(12) Patent Application Publication
(10) Pub. No.: US 2017/0081150 A1
(43) Pub. Date: Mar. 23, 2017

(54) Elevator Alert Status Indicator

(71) Applicant: CE Electronics, Inc., Bryan, OH (US)

(72) Inventors: Kevin Schroer, Bryan, OH (US); Charlie Simpkins, Ft. Wayne, IN (US)

(73) Assignee: CE Electronics, Inc., Bryan, OH (US)

(21) Appl. No.: 15/270,388

(22) Filed: Sep. 20, 2016

Related U.S. Application Data
(60) Provisional application No. 62/222,392, filed on Sep. 23, 2015.

(51) Int. Cl. B66B 5/00; B66B 1/34

(52) U.S. Cl. CPC B66B 5/0018; B66B 1/3446

(57) ABSTRACT

This unique Elevator Alert Status Indicator (EASI) system monitors a number of electors for different error conditions. If a problem occurs, a pictorial representation of the problem will be shown on a screw, along with an alphanumeric elevator location. This system will also sound an alarm for certain high importance problems to get the attention of maintenance and other staff of the building. However, any fault condition can be chosen to sound an alarm.

### CROSS REFERENCE TO RELATED APPLICATION

This application claims the benefit of U.S. provisional patent application Ser. No. 62/222,392 filed on Sep. 23, 2015.

### TECHNICAL FIELD

This invention relates to a unique Elevator Alert Status Indicator (EASI) system. The EASI system monitors a number of elevators for different error conditions.

### BACKGROUND OF THE INVENTION

There are known devices that diagnose situations in an elevator system. The devices are capable of recording and providing some form of visible indication regarding the recording. For example, some known devices provide a graphical output indicating parameters detected by the device.

Those skilled in the art are always striving to make improvements. It would be useful to provide enhanced capabilities for monitoring in elevator systems and to improve efficiencies associated with diagnosing and correcting or servicing elevator system components.

It would be desirable to have a signaling device to automatically warn elevator passengers and maintenance personnel when a problem arises. Thus an elevator alert solving the aforementioned problem is desired

### SUMMARY OF THE INVENTION

This Elevator Alert Status Indicator (EASI) system monitors a number of elevators for different error conditions. If a problem occurs, a pictorial representation of the problem will be shown on a screen, along with an alphanumeric elevator location. This system will also sound an alarm for certain, high importance problems to get the attention of maintenance and other staff of the building. If multiple problems are occurring at once, a number will appear at the top of the screen to show that there is more than one thing wrong. By default, the issue with the highest priority (which may be assigned in the field) will appear, and the problems with less priority may be viewed by pressing a button.

Each unit is able to support up to 8 elevators and 8 different error types, as limited by the auxiliary input boards. The EASI utilizes a Controller Area Network (CAN) protocol to communicate between the input boards and display. Each input board is addressed as certain error type, while the discrete inputs on the hoard are for the different elevators in a group.

Other objects and advantages of the present invention will become apparent to those skilled in the art upon a review of the following detailed description of the preferred embodiments and the accompanying drawings.

### IN THE DRAWINGS

FIG. 1 is a simplified block diagram of EASI apparatus in accordance with an embodiment of the present invention.

FIG. 2 is an illustration of a typical EASI display.

### DETAILED DESCRIPTION OF THE INVENTION

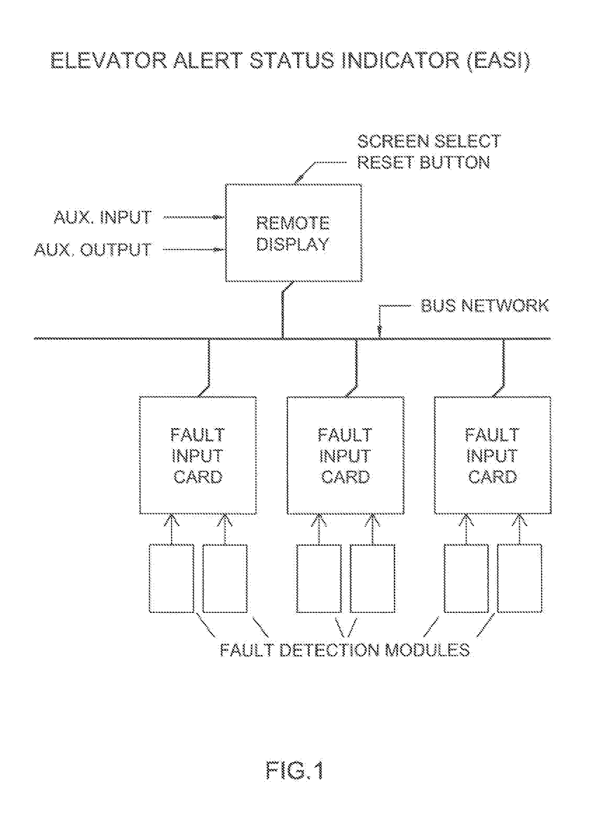

FIG. 1 shows a simplified block diagram of EASI apparatus in accordance with an embodiment of the present invention. The EASI system is for monitoring an elevator arrangement. The EASI system includes a detector arranged to detect an event or a condition in, on or near an associated elevated car; and a monitoring device that is configured to monitor a status of the elevator arrangement. The system communicates with the detector for receiving data indicative of any event or condition detected by the detector, and provides an output that associates the monitored status of the elevator arrangement at a time of any detected event or condition with an indication of the defected event or condition that can be communicated to a location remote from the monitoring device, the reproduction including a visual output indicative of the detected event and a corresponding audible output of the same sound.

The Elevator Alert Status Indicator (EASI) is a multi-function display that is able to be mounted in new or existing hall button stations. This small display is able to monitor a number of elevators for different error conditions. If a problem occurs, a pictorial representation of the problem will be shown on a colored screen, along with an alphanumeric elevator location. This indication will stay on the screen until the fault or faults are repaired. This system will also sound an alarm if the fault is of high importance. This will audibly get the attention of maintenance and other staff of the building. The alarm can be silenced but will alarm again at a defined programmed duration of time if the fault is not fixed. Being located in the half station makes installation inexpensive because there is no need for an additional fixture as every building already has a hall button fixture requirement.

Preferably, the pictorial representation of the highest priority fault is presented in color. The preferred color is red. The color also may be a highly visible color such as neon green or neon orange.

In one embodiment, an alarm sounds on high priority errors. In another embodiment, the determination of which fault conditions cause an alarm to sound can be set and changed in the field. In this way, any fault condition can be chosen to cause an alarm to sound. There is no limit to how many different conditions can sound this alarm. It can be chosen to have every fault cause an alarm, no faults cause an alarm, or anywhere in between.

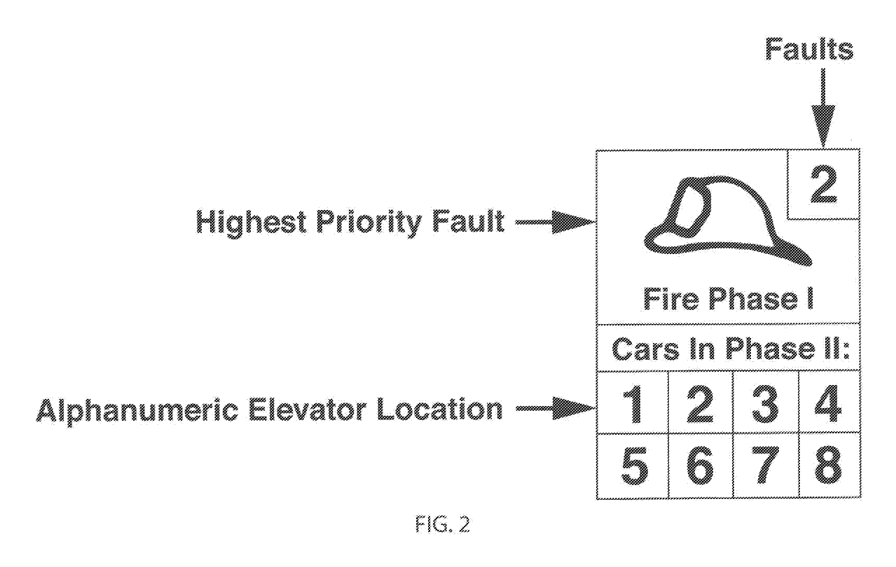

FIG. 2 is an illustration of a typical EASI display.

If multiple faults are occurring at once, a number will appear at the top of the screen to show that there is more than one thing wrong. The fault with the highest priority will appear on the screen. All faults can be reviewed in order of importance. During the review you will see the cause for the fault and the elevators with the fault.

Each unit is able to support multiple elevators and multiple error types. The EASI system utilizes a serial Network protocol to communicate between the input boards and the display. Each input board is addressed to ascertain the error type, and which elevator in the group is causing the error. The system can handle multiple errors and faulty elevators at the same time.

Common Faults and indications displayed but not limited to:
Water in Pit
Cab Light Fault
Phone Line Fault
Fire Phase 1
Fire Phase 2
Fire Jewel Indication
Emergency Power

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. An EASI system for monitoring an elevator arrangement, comprising:
a detector arranged to detect an event or a condition in, on or near an associated elevated car; and
a monitoring device that is configured to monitor a status of the elevator arrangement,
communicate with the detector for receiving data indicative of any event or condition detected by the detector, and
provide an output that associates the monitored status of the elevator arrangement at a time of any detected event or condition with an indication of the detected event or condition that can be communicated to a location remote from the monitoring device, the reproduction including a visual output indicative of the detected event and a corresponding audible output of the same sound.

2. The EASI system of claim 1, wherein the monitoring device is configured to communicate the output to another device remotely located from a site of the monitoring device.

3. The EASI system of claim 2, wherein the monitoring device determines a baseline reference of at least one acceptable event or condition;
determines whether any detected event or condition has an expected relationship with a corresponding acceptable event or condition; and
provides the output to the other device responsive to the detected event or condition not having the expected relationship with the corresponding acceptable event or condition.

4. The EASI system of claim 1, comprising:
a processor located remotely from the site of the monitoring device, the processor receiving the output from the monitoring device and generating a corresponding output that provides the reproduction of the detected event or condition.

5. The EASI system of claim 4, wherein the processor generates an audible output representing a detected sound and a visible output representing the detected sound in association with the status of the elevator arrangement at the time of the detected sound.

6. The EASI system of claim wherein one of the monitoring device or the processor digitizes the indication of the detected sound such that the corresponding sound file is digitized.

7. The EASI system of claim 1 further comprising multiple input boards configured to support multiple elevators and configured to detect multiple different error events.

8. The EASI system of claim 7 further comprising a Controller Area Network (CAN) protocol configured to communicate between the input boards and a visual output.

9. The EASI system of claim 7 wherein each of the input boards is configured to address a certain error type.

10. The EASI system of claim 9 wherein each of the input boards also is configured to address different elevators in a group.

11. The EASI system of claim 7 wherein the multiple input boards are configured to prioritize the multiple different error events.
